(19) United States
(12) Patent Application Publication
(10) Pub. No.: US 2014/0173719 A1
(43) Pub. Date: Jun. 19, 2014

(54) INDUSTRIAL MANIPULATING SYSTEM WITH MULTIPLE COMPUTERS AND INDUSTRIAL MANIPULATING METHOD

(71) Applicants: HON HAI PRECISION INDUSTRY CO., LTD., New Taipei (TW); Fu Tai Hua Industry (Shenzhen) Co., Ltd., Shenzhen (CN)

(72) Inventor: QI-DI WU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/108,408

(22) Filed: Dec. 17, 2013

(30) Foreign Application Priority Data
Dec. 18, 2012 (CN) 2012105506595

(51) Int. Cl. G06F 21/32

(52) U.S. Cl. CPC G06F 21/32
USPC 726/19

(57) ABSTRACT

An industrial manipulating system includes a plurality of computers and an input assembly shared by the computers. A response capability of the computer is interrupted to operation commands. A camera is used to take a photograph of a current operator and determination is made whether the photograph contains a face image of the current operator. The response capability of the identified computer is restored to the operation commands when the photograph contains the face image of the current operator.

### CROSS-REFERENCE TO RELATED APPLICATIONS

This application claims all benefits accruing under 35 U.S.C. §119 from China Patent Application No. 201210550659.5, filed on Dec. 18, 2012 in the China Intellectual Property Office, the content of which is hereby incorporated by reference in its entirety.

### BACKGROUND

1. Technical Field

The present disclosure relates to an industrial manipulating system with multiple computers and an industrial manipulating method applicable to the industrial manipulating system.

2. Description of Related Art

Computers are widely used in industrial manipulating systems. A typical industrial manipulating system includes multiple computers which are usually manipulated by a single operator; each of the computers includes a respective input device such as a keyboard. When the operator desires to manipulate a target computer of the industrial manipulating system, the operator needs to choose a corresponding input device of the target computer and input an operation command using the input device. However, because each of the computers has a respective input device, the operator may mistakenly use an input device of other computers to input the operation command. This may bring an incorrect operation of the industrial manipulating system.

What is needed is to provide a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram of an industrial manipulating system according to an embodiment of the present disclosure, the industrial manipulating system including a plurality of computers.

FIG. 2 is a schematic block diagram of one of the computers in the industrial manipulating system of FIG. 1.

FIG. 3 is a flowchart of an industrial manipulating method according to one embodiment of the present disclosure.

FIG. 4 and FIG. 5 are a flowchart of an industrial manipulating method according to another embodiment of the present disclosure.

### DETAILED DESCRIPTION

Reference will now be made to the drawings to describe various embodiments in detail.

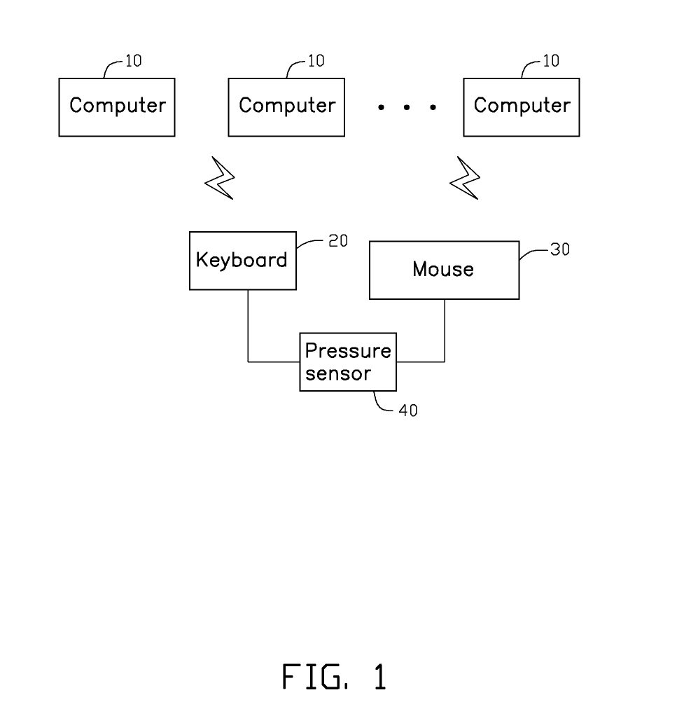

An industrial manipulating system according to an embodiment of the present disclosure is illustrated in FIG. 1, the industrial manipulating system includes a plurality of computers 10 and an input assembly including a keyboard 20 and a mouse 30. The computers 10 shares the input assembly, where the keyboard 20 and the mouse 30 can be used to input operation commands to all of the computers 10. In the present disclosure, the input assembly is in communication with the computers 10 in a wireless mode, for example, the keyboard 20 and the mouse 30 may be wireless devices communicating with the computers via BLUETOOTH connections. Moreover, the industrial manipulating system may optionally include a pressure sensor 40 electrically connected to the keyboard 20 and the mouse 30.

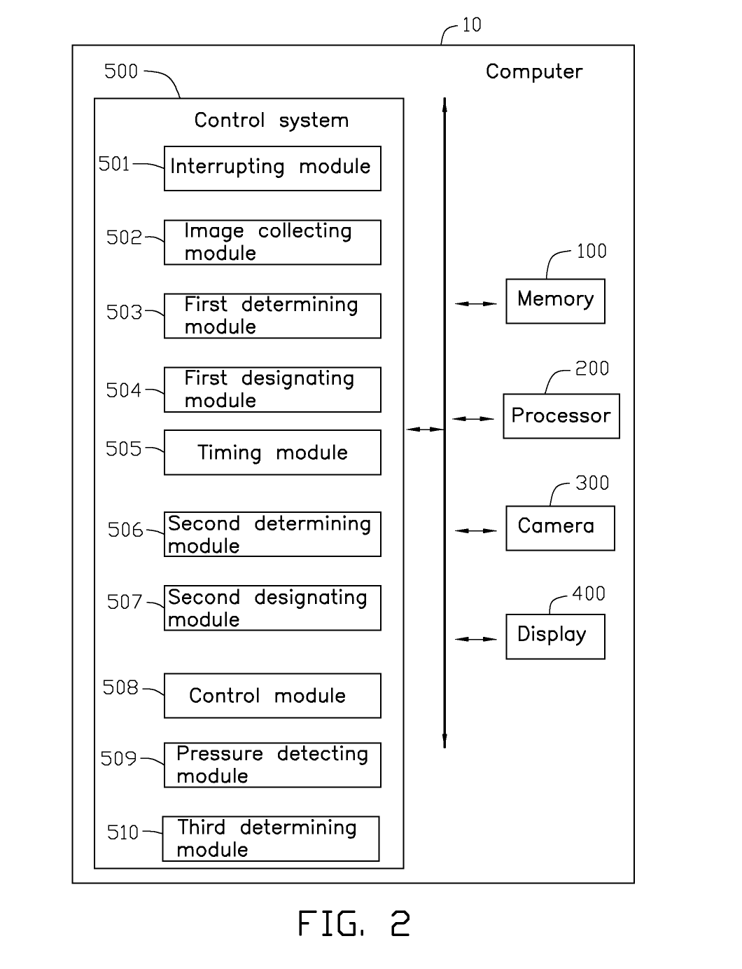

FIG. 2 illustrates a schematic block diagram of the computer 10. Each of the computers 10 in the industrial manipulating system includes a memory 100, a processor 200, a camera 300, a display 400 and a control system 500. The memory 100 stores programs that can be implemented by the processor 200; and the memory 100 may also pre-store images of legitimate operators. The camera 300 is used to collect an image of a current operator, and may be embedded in the display 400.

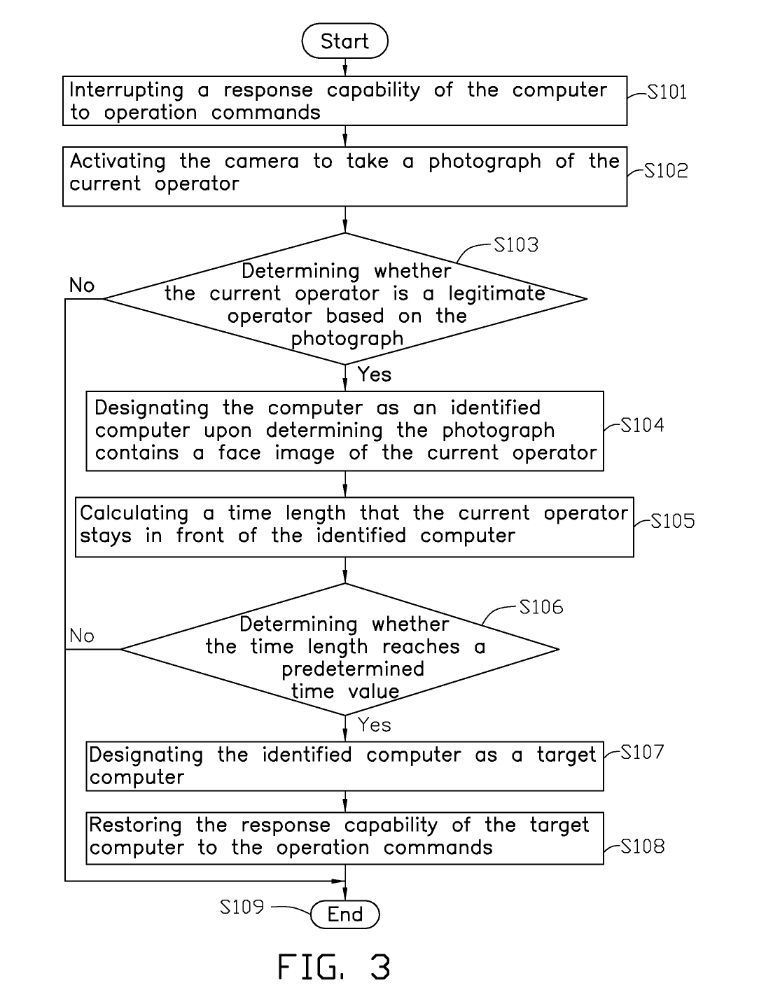

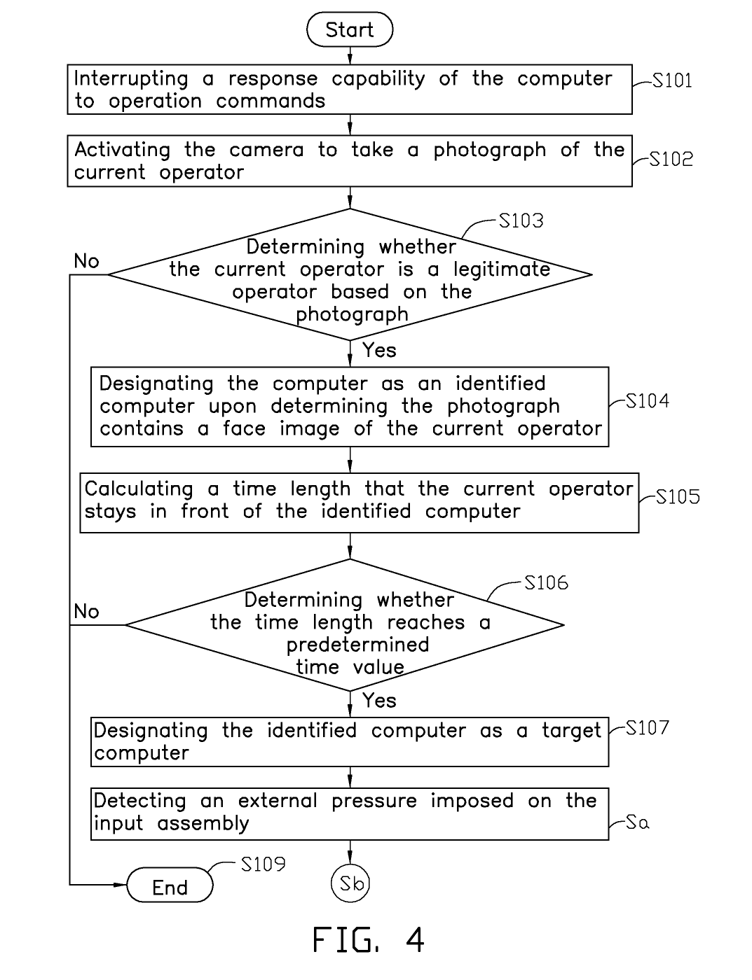

The control system 500 may be firmware that is installed in the memory 100 and can be executed by the processor 200. The control system 500 includes an interrupting module 501, an image collecting module 502, a first determining module 503, a first designating module 504, a timing module 505, a second determining module 506, a second designating module 507 and a control module 508. Optionally, the control system 500 may further includes a pressure detecting module 509 and a third determining module 510. The functionality of the above-mentioned modules 501-510 in the control system 500 will be described in accompany with the industrial manipulating methods as illustrated in FIGS. 3-4.

FIG. 3 illustrates an industrial manipulating method according to an embodiment of the present disclosure; the industrial manipulating method as illustrated in FIG. 3 includes the following steps.

Step S101, a response capability of the computer 10 to operation commands is interrupted. Interruption of the operation commands means that the computer 10 stops responding from operation commands from the input device (such as the keyboard 20 or the mouse 30).

In detail, when the control system 500 starts the industrial manipulating method, the interrupting module 501 of the control system 500 is utilized to interrupt response capability of the computer 10 to the operation commands that are input from the keyboard 20 or the mouse 30, and thus the computer 10 will not response to an operation command until the response capability of the computer 10 is restored.

Step S102, the camera 300 of the computer 10 is activated to take a photograph of the current operator.

For example, the control system 500 may utilize the image collecting module 502 to activate the camera 300 and control the camera 300 to take a photograph of a face of the current operator, and thus a face photograph of the current operator is obtained.

Step S103, the control system 500 determines whether the current operator is a legitimate operator based on the photograph, if the current operator is a legitimate operator based on the photograph, the method turns to step S104, otherwise, turns to step S109 to end the method.

In this step, the control system 500 may utilize the first determining module 502 to determine whether the current operator is an legitimate operator, for example, the first determining module 502 may compare the photograph with the pre-stored images of legitimate operators in the memory 100, and upon the condition that the photograph matches one of the pre-stored images, the first determining module 502 determines that the current operator is a legitimate operator, and vice versa.

In one embodiment, if a weighted mean value of facial characteristics, eye characteristics, and nose characteristics of the photograph reaches a predetermined percentage of a weighted mean value of facial characteristics, eye characteristics, and nose characteristics of a pre-stored image, it is determined that the photograph matches the pre-stored image and thus the current operator is a legitimate operator. The predetermined percentage may for example be defined as substantially equal to 85%.

Step S104, the control system 500 determines whether the photograph contains a face image of the current operator, and if the photograph contains a face image of the current operator, the computer 10 is designated as an identified computer.

Specifically, when an operator desires to manipulate a target computer, the operator always stays in a pre-defined region in front of the display of the target computer and faces the display, thus the camera embedded in the display can take a face image of the operator. Accordingly, when the photograph obtained in step S102 contains a face image of the current operator, it is indicated that the current operator stays in the pre-defined region in front of the display 400 and desires to manipulate the computer 10 to which the display 400 and the camera 300 belong; therefore, the first designating module 504 may designate the computer 10 as an identified computer. In particular, the pre-defined region may be defined as a region which is less than one meter from a display surface of the display 400 and within an angle range from −45 degrees to 45 degrees in relative to a central point of the display surface.

Step S105, a time length that the current operator stays in front of the identified computer 10 is calculated.

The control system 500 may utilize the timing module 505 to calculate a time length that the current operator stays in front of the identified computer, for example, the timing module 505 starts a timing process once the current operator enters the pre-defined region in front of the identified computer 10, and the timing process is ended when the current operator leaves from the pre-defined region in front of the identified computer 10.

Step S106, the control system 500 determines whether the time length reaches a predetermined time value, if the time length reaches a predetermined time value, the method turns to step S107, otherwise, turns to step S109 to end the method.

In this step, the second determining module 506 is utilized by the control system 500 to determine whether the time length that the current operator stays in the pre-defined region in front of the identified computer 10 reaches a predetermined time value such as a value selected in a range from 2 to 5 seconds.

Step S107, the identified computer 10 is designated as a target computer.

When the second determining module 506 determines that the time length reaches the predetermined time value, it is indicated the current operator does not merely passes through the identified computer, instead, the current operator desires to input operation commands to the identified computer 10 to manipulate the identifier computer 10 to carry out some operation, therefore, the control system 500 may utilize the second designating module 507 to designate the identified computer 10 as a target computer.

Step S108, the response capability of the target computer to the operation commands is restored.

Once the target computer is designated, the control system 500 may utilize the control module 508 to restore the response capability of the target computer 10 to the operation commands, so that the target computer 10 can carry out corresponding operation in responsive to the operation commands input by the current operator through the input assembly.

It should be noted that it is unneeded to implement the steps in the method according to the above-described order, for example, steps S105 and S106 may be implemented simultaneously as or before steps S103-104. Moreover, some of the steps S101-S109 may be optional, for example, steps 105-106 may be omitted thus the identified computer 10 can be directed treated as the target computer.

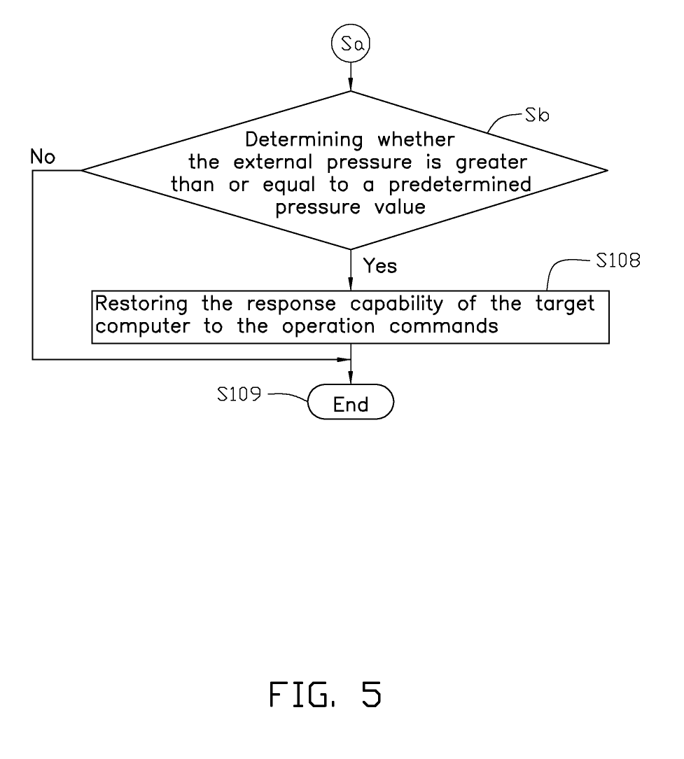

FIG. 4 and FIG. 5 illustrate an industrial manipulating method according to another embodiment of the present disclosure; the industrial manipulating method as illustrated in FIG. 4 and FIG. 5 are similar to the industrial manipulating method as illustrated in FIG. 3, but differs in that the industrial manipulating method further includes steps Sa and Sb as described below between step S107 and step S108.

Step Sa, an external pressure imposed on the input assembly is detected.

After the target computer is designated, the control system 500 may utilize the pressure detecting module 509 to activate the pressure sensor 40 to detect an external pressure imposed on the input assembly, and the pressure detecting module 509 may further collect external pressure information from the pressure sensor 40.

Step Sb, the control system 500 determines whether the external pressure is greater than or equal to a predetermined pressure value, if so, the method turns to step S108, if not, turns to step S109 to end the method.

After the external pressure information is collected from the pressure sensor 40, the control system 500 may utilize the third determining module 510 to compare the external pressure with a predetermined pressure value, the predetermined pressure value may be defined as a pressure imposed on the keyboard 20 or the mouse 30 when the current operator put his or her hand on the keyboard 20 or the mouse 30. If the external pressure is greater than or equal to the predetermined pressure value, the method turns to step S108 to restore the response capability of the target computer 10 to the operation commands; if the external pressure is less than the predetermined pressure value, the method turns to step S109 to end the method.

In the industrial manipulating methods as described above, the multiple computers 10 within the industrial manipulating system share a same input assembly, in addition, the control system 500 is capable of determine which of the computers 10 within the industrial manipulating system is the target computer of the current operator, and only the response capability of the target computer to the operation commands is restored while others are interrupted. Therefore, it can be ensured that the operation commands input by the current operator can be response to by the target computer, so that the possibility of incorrect operation the industrial manipulating system is decreased.

It is to be understood that even though numerous characteristics and advantages of the present embodiments have been set forth in the foregoing description, together with details of the structures and functions of the embodiments, the disclosure is illustrative only; and that changes may be made in detail, especially in matters of shape, size, and arrangement of parts, within the principles of the embodiments, to the full extent indicated by the broad general meaning of the terms in which the appended claims are expressed.

What is claimed is:

1. An industrial manipulating method, comprising:
interrupting a response capability of a computer to operation commands;
obtaining a photograph of a current operator of the computer;
determining whether the photograph contains a face image of the current operator; and
restoring the response capability of the identified computer to the operation commands when the photograph contains the face image of the current operator.

2. The industrial manipulating method of claim 1, further comprising:
determining whether the current operator is a legitimate operator by determining whether the photograph of the current operator matches a pre-stored image of legitimate operators.

3. The industrial manipulating method of claim 2, wherein the determining whether the photograph contains a face image of the current operator is implemented if the current operator is determined as a legitimate operator.

4. The industrial manipulating method of claim 2, wherein the determining whether the photograph of the current operator matches one of pre-stored images of legitimate operators comprises:
determining whether a weighted mean value of facial characteristics, eye characteristics, and nose characteristics of the photograph reaches a predetermined percentage of a weighted mean value of facial characteristics, eye characteristics, and nose characteristics of one of the pre-stored images, if the a weighted mean value of facial characteristics, eye characteristics, and nose characteristics of the photograph reaches a predetermined percentage of a weighted mean value of facial characteristics, eye characteristics, and nose characteristics of one of the pre-stored images, determining that the photograph of the current operator matches the pre-stored image.

5. The industrial manipulating method of claim 1, further comprises:
calculating a time length that the current operator stays in front of the computer after determining the photograph contains the face image of the current operator; and
determining whether the time length reaches a predetermined time value.

6. The industrial manipulating method of claim 5, further comprising:
designating the computer as a target computer if the time length reaches a predetermined time value.

7. The industrial manipulating method of claim 5, further comprises:
detecting an external pressure imposed on an input assembly after determining that the time length reaches the predetermined time value; and
determining whether the external pressure is greater than or equal to a predetermined pressure value.

8. The industrial manipulating method of claim 5, wherein the designating the computer as a target computer is implemented if the external pressure is greater than or equal to a predetermined pressure value.

9. The industrial manipulating method of claim 1, wherein the obtaining a photograph of a current operator comprises:
activating a camera embedded in a display; and
controlling the camera to take a photograph on a face of the current operator.

10. An industrial manipulating system, comprising:
a plurality of computers; and
an input assembly shared by the computers;
wherein each computer comprises a memory, a processor, a camera, and a control system, the control system is installed in the memory and executed by the processor, wherein the control system comprises:
an interrupting module interrupting a response capability of the computer to operation commands;
an image collecting module controlling the camera to take a photograph of a current operator;
a first designating module determining whether the photograph contains a face image of the current operator; and
a control module restoring the response capability of the identified computer to the operation commands when the photograph contains a face image of the current operator.

11. The industrial manipulating system of claim 10, wherein the control system further comprises a first determining module for determining whether the current operator is a legitimate operator.

12. The industrial manipulating system of claim 11, wherein images of legitimate operators are pre-stored in the memory, and the first determining module determines whether the photograph of the current operator matches one of pre-stored images of legitimate operators to determine whether the current operator is a legitimate operator.

13. The industrial manipulating system of claim 12, wherein the first determining module determines that the photograph of the current operator matches one of pre-stored images of legitimate operators when a weighted mean value of facial characteristics, eye characteristics, and nose characteristics of the photograph reaches a predetermined percentage of a weighted mean value of facial characteristics, eye characteristics, and nose characteristics of one of the pre-stored images.

14. The industrial manipulating system of claim 10, wherein the control system further comprises a timing module for calculating a time length that the current operator stays in front of the computer.

15. The industrial manipulating system of claim 14, wherein the control system further comprises a second determining module for determining whether the time length reaches a predetermined time value.

16. The industrial manipulating system of claim 14, wherein the control system further comprises a second designating module for designating the computer as a target computer if the time length reaches a predetermined time value.

17. The industrial manipulating system of claim 10, further comprising a pressure sensor connected to the input assembly, the pressure sensor is configured to detect an external pressure imposed on the input assembly.

18. The industrial manipulating system of claim 10, wherein the control system further comprises a pressure detecting module for controlling the pressure sensor to detect the external pressure imposed on the input assembly and collecting external pressure information from the pressure sensor.

19. The industrial manipulating system of claim 18, wherein the control system further comprises a third determining module for determining whether the external pressure is greater than or equal to a predetermined pressure value.

20. The industrial manipulating system of claim 10, wherein the computer further comprises a display, and the camera is embedded in the display.
